(19) United States
(12) Patent Application Publication
(10) Pub. No.: US 2015/0015531 A1
(43) Pub. Date: Jan. 15, 2015

(54) TOUCH SCREEN TO RECOGNIZE REMOTE GESTURE AND CONTROLLING METHOD THEREOF

(71) Applicant: SAMSUNG ELECTRO-MECHANICS CO., LTD., Suwon (KR)

(72) Inventors: Hyun Jun Kim, Suwon (KR); Kyoung Soo Chae, Suwon (KR); Tah Joon Park, Suwon (KR)

(73) Assignee: SAMSUNG ELECTRO-MECHANICS CO., LTD., Suwon (KR)

(21) Appl. No.: 14/061,164

(22) Filed: Oct. 23, 2013

(30) Foreign Application Priority Data
Jul. 9, 2013 (KR) 10-2013-0080420

(51) Int. Cl. G06F 3/0488; G06F 3/044

(52) U.S. Cl. CPC G06F 3/04883; G06F 3/044
USPC 345/174

(57) ABSTRACT

Disclosed herein is a touch screen to recognize a remote gesture including a touch panel, a mode selecting unit, first and second switching circuit units and a controlling unit. Slimness and lightness of a mobile device having the touch screen may be realized by integrating touch and remote gesture recognition functions with the electrode patterns by switching operations of the first and second switching circuit units. In addition, a signal to noise ratio (SNR) available for both the touch and remote gesture recognitions may be secured by forming a width of a first electrode pattern of the touch screen in a metal mesh pattern having a wider width than a mutual induced capacitive type according to the prior art.

### CROSS REFERENCE TO RELATED APPLICATION

This application claims the benefit of Korean Patent Application No. 10-2013-0080420, filed on Jul. 9, 2013, entitled “Touch Screen to Recognize a Remote Gesture and Controlling Method Thereof”, which is hereby incorporated by reference in its entirety into this application.

### BACKGROUND OF THE INVENTION

1. Technical Field

The present invention relates to a touch screen to recognize a remote gesture and a controlling method thereof.

2. Description of the Related Art

In accordance with the growth of computers using a digital technology, devices assisting computers have also been developed, and personal computers, portable transmitters and other personal information processors, or the like execute processing of text and graphics using a variety of input devices such as a keyboard and a mouse.

However, current techniques for input devices have progressed toward techniques related to high reliability, durability, innovation, designing and processing beyond the level of satisfying general functions. To this end, a capacitive type touch panel has been developed as an input device capable of inputting information such as text, graphics, or the like.

In addition, the touch panel is classified into a resistive type touch panel, a capacitive type touch panel, an electromagnetic type touch panel, a surface acoustic wave (SAW) type touch panel, and an infrared type touch panel. These various types of capacitive type touch panels are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch panel and the capacitive type touch panel have been prominently used in a wide range of fields.

In addition, as smartphones having high-performance become popular, it has been required that various sensor functions (for example, touch sensing, low-diameter stylus pen supporting, proximity sensing, remote gesture recognition functions, or the like) are mounted on the capacitive type touch panel.

However, since the capacitive type touch panel has different structures, driving schemes, and the like of a sensor electrode pattern suitable for various sensor functions such as Patent Document described in the following prior art document, it may be difficult to integrate the capacitive type touch panel with the sensor functions.

### PRIOR ART DOCUMENT

### Patent Document

(Patent Document 1) KR2011-0057501

### SUMMARY OF THE INVENTION

The present invention has been made in an effort to provide a touch screen to recognize a remote gesture capable of manipulating a portable device without touching a touch panel by sensing a touch input of a user and a gesture of the user on the touch panel even in a situation in which the touch input is difficult, and a controlling method thereof.

According to a preferred embodiment of the present invention, there is provided a touch screen to recognize a remote gesture, the touch screen including: a touch panel including a plurality of first and second electrode patterns formed in a direction intersected with each other on a substrate; a mode selecting unit selecting an operation mode of the touch panel from a touch recognition mode and a remote gesture recognition mode; a first switching circuit unit electrically connected to the first electrode pattern by a switching operation according to the selection of the operation mode of the touch panel; a second switching circuit unit electrically connected to the second electrode pattern by a switching operation according to the selection of the operation mode of the touch panel; and a controlling unit controlling the switching operations of the first switching circuit unit and the second switching circuit unit and a driving signal applied to the first electrode pattern and the second electrode pattern, and detecting changes in capacitance sensed from the first electrode pattern and the second electrode pattern according to the selection of the operation mode of the touch panel.

When the touch recognition mode is selected from the mode selecting unit, the first switching circuit unit may be electrically connected to all of the first electrode patterns by the switching operation, the second switching circuit unit may be electrically connected to all of the second electrode patterns by the switching operation, and the controlling unit may sequentially apply the driving signal to the second electrode patterns through the second switching circuit unit, detect a change in mutual capacitance sensed from the first electrode patterns, and determine a touch location.

When the remote gesture recognition mode is selected from the mode selecting unit, the first switching circuit unit may form a first electrode pattern group comprised of one or more first electrode patterns by the switching operation; the second switching circuit unit may form a second electrode pattern group comprised of one or more second electrode patterns by the switching operation, and the controlling unit may sequentially apply the driving signal to the first electrode pattern group through the first switching circuit unit, sense a time difference between changes in self-capacitances in the first electrode pattern group according to a gesture input in an up and down direction by a user, and determine whether or not the gesture in the up and down direction is input by the user, and sequentially apply the driving signal to the second electrode pattern group through the second switching circuit unit, sense a time difference between changes in self-capacitances in the second electrode pattern group according to a gesture input in a left and right direction by the user, and determine whether or not the gesture in the left and right direction is input by the user.

The touch panel may include the substrate, the first electrode patterns formed on one surface of the substrate so as to be parallel with each other in one direction, and the second electrode patterns formed on a rear surface of the substrate and formed so as to be parallel with each other in a direction intersecting with the first electrode patterns.

The first electrode pattern may be a mesh pattern.

The first electrode pattern may have a width similar to a width of the second electrode pattern.

The controlling unit may include: a driving circuit module applying a predetermined driving signal to the touch panel, a sensing circuit module sensing a change in the capacitance in the touch panel and generating an analog signal corresponding to the change, a signal converting module converting the analog signal into a digital signal, an operating module operating a coordinate of a touch input applied to the touch panel using the digital signal, and a controller controlling the first and second switching circuit units, the driving circuit module, the signal converting module, and the operating module.

According to another preferred embodiment of the present invention, there is provided a controlling method of a touch screen to recognize a remote gesture, the method including: performing a touch recognition mode detecting a change in mutual induced capacitance sensed from a first electrode pattern according to a driving signal sequentially applied to a second electrode pattern of a touch panel to thereby determine a touch location; selecting a mode selecting whether or not switching from the touch recognition mode to a remote gesture recognition mode; when the remote gesture recognition mode is selected, performing the remote gesture recognition mode forming first and second electrode pattern groups and then sensing a time difference between changes in self-capacitance in the first and second electrode pattern groups according to a gesture of a user; and determining whether or not terminating the remote gesture recognition mode selecting whether or not switching from the remote gesture recognition mode to the touch recognition mode according to whether or not a specific gesture is input.

The touch panel may include a substrate, the first electrode patterns formed on one surface of the substrate so as to be parallel with each other in one direction, and the second electrode patterns formed on a rear surface of the substrate and formed so as to be parallel with each other in a direction intersecting with the first electrode patterns.

The first electrode pattern may be a mesh pattern.

The first electrode pattern may have a width similar to a width of the second electrode pattern.

In the performing of the remote gesture recognition mode, the first electrode pattern group comprised of one or more first electrode patterns may be formed by a switching operation of a first switching circuit unit, and the second electrode pattern group comprised of one or more second electrode patterns may be formed by a switching operation of a second switching circuit unit.

In the performing of the remote gesture recognition mode, the driving signal may be sequentially applied to the first electrode pattern group through the first switching circuit unit and a time difference between changes in self-capacitances in the first electrode pattern group according to a gesture input by a user in an up and down direction may be sensed to thereby determine whether or not the user inputs a gesture in the up and down direction, and the driving signal may be sequentially applied to the second electrode pattern group through the second switching circuit unit and a time difference between changes in self-capacitances in the second electrode pattern group according to a gesture input by the user in a left and right direction may be sensed to thereby determine whether or not the user inputs a gesture in the left and right direction.

After the determining of whether or not terminating the remote gesture recognition mode, when the remote gesture recognition mode is not terminated, the performing of the remote gesture recognition mode may be repeatedly performed.

The method may further include, after the determining of whether or not terminating the remote gesture recognition mode, releasing the first and second electrode pattern groups by electrically connecting the first switching circuit unit to all of the first electrode patterns through a switching operation and electrically connecting the second switching circuit unit to all of the second electrode patterns through a switching operation when the remote gesture recognition mode is terminated.

The method may further include, after the releasing of the first and second electrode pattern groups, determining whether or not terminating the touch recognition mode determining whether or not re-performing the touch recognition mode.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of a touch screen to recognize a remote gesture according to a preferred embodiment of the present invention;

FIG. 2A is a plan view of a touch panel according to a preferred embodiment of the present invention and FIG. 2B is a cross-sectional view taken along the line A-A′ of FIG. 2A;

FIG. 3 is a diagram showing a driving scheme in a touch recognition mode of the touch screen to recognize the remote gesture according to a preferred embodiment of the present invention;

FIG. 4A is a circuit diagram showing a grouping scheme of a first electrode pattern in the remote gesture recognition mode of the touch screen to recognize the remote gesture according to a preferred embodiment of the present invention and FIG. 4B is a diagram showing a sweeping gesture of a user in an up and down direction in the case in which the first electrode pattern is grouped;

FIG. 5A is a circuit diagram showing a grouping scheme of a second electrode pattern in the remote gesture recognition mode of the touch screen to recognize the remote gesture according to a preferred embodiment of the present invention and FIG. 5B is a diagram showing a sweeping gesture of the user in a left and right direction in the case in which the second electrode pattern is grouped;

FIG. 6 is diagram showing a gesture for terminating the remote gesture recognition mode of the touch screen to recognize the remote gesture according to the preferred embodiment of the present invention;

FIG. 7 is a flow chart showing a controlling method of the touch screen to recognize the remote gesture according to a preferred embodiment of the present invention; and

FIG. 8 is a diagram showing a controlling unit of the touch screen to recognize the remote gesture according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the accompanying drawings.

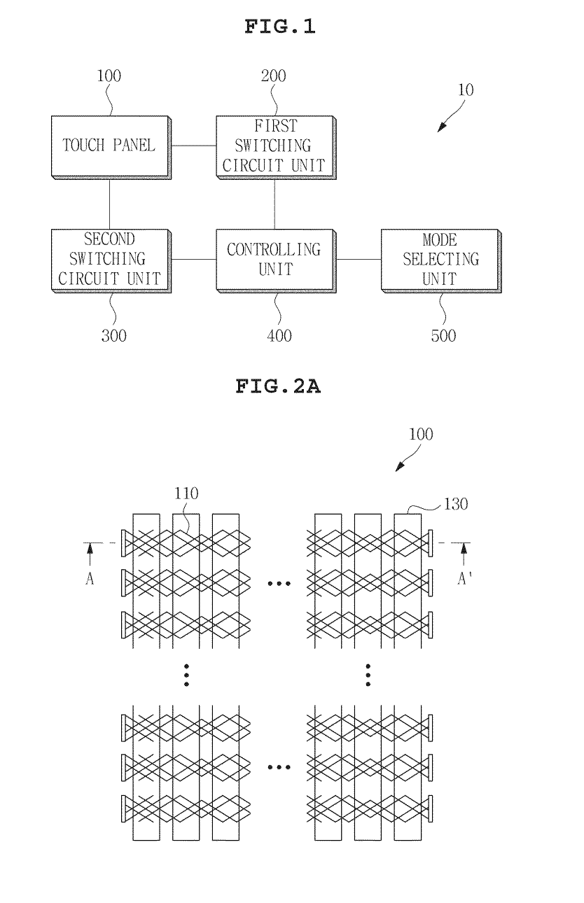

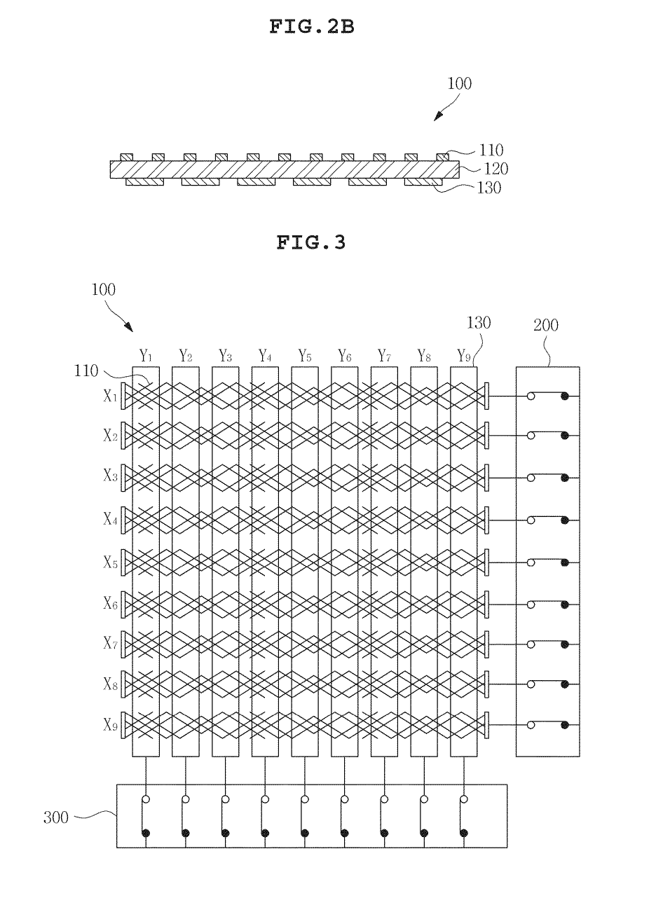

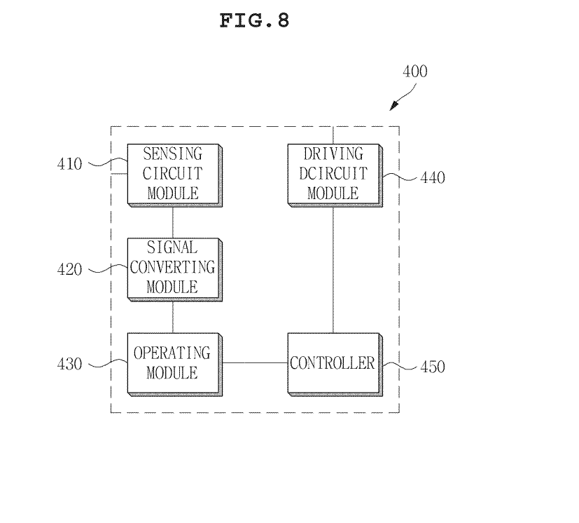

FIG. 1 is a block diagram of a touch screen to recognize a remote gesture according to a preferred embodiment of the present invention, FIG. 2A is a plan view of a touch panel according to a preferred embodiment of the present invention, FIG. 2B is a cross-sectional view of the touch panel taken along the line A-A′ of FIG. 2A, and FIG. 8 is a diagram showing a controlling unit of the touch screen.

As shown in FIGS. 1 and 8, a touch screen to recognize a remote gesture according to a preferred embodiment of the present invention includes a touch panel, a first switching circuit unit, a second switching circuit unit, a controlling unit, and a mode selecting unit, wherein the controlling unit includes a sensing circuit module, a signal converting module, an operating module, a driving circuit module, and a controller.

As shown in FIGS. 2A and 2B, the touch panel 100 includes a substrate 120, first electrode patterns 110 formed on one surface of the substrate 120 so as to be parallel with each other in one direction, and second electrode patterns 130 formed on a rear surface of the substrate 120 and formed so as to be parallel with each other in a direction intersecting with the first electrode pattern 110.

Here, the substrate 120 serves to provide a region in which electrode patterns, electrode wirings, and the like will be formed and is not particularly limited as long as it is a material having a predetermined intensity or more, but may be made of polyethylene terephthalate (PET), polycarbonate (PC), poly methyl methacrylate (PMMA), glass, tempered glass, or the like.

The first electrode pattern 110 may be formed in a mesh pattern using copper (Cu), aluminum (Al), gold (Au), silver (Ag), titanium (Ti), palladium (Pd), chromium (Cr), or a combination thereof and the second electrode pattern may be formed in the mesh pattern or a bar electrode structure of a solid type.

In addition, in a case of a mutual-induced capacitive type touch screen according to the prior art, the first electrode pattern (an upper electrode pattern) 110 is formed so as to have a relatively narrower width than the second electrode pattern (a lower electrode pattern) 130 based on resistance limitation in order not to block a coupling with the second electrode pattern (the lower electrode pattern) 130 and a touch input unit by an electric field. However, in the case in which the first electrode pattern is formed in a metal mesh pattern having a wide width, a SNR capable of recognizing all of a touch and a remote gesture may be obtained.

That is, in the case in which the first electrode pattern 110 is formed in the metal mesh pattern, since the first electrode pattern 110 does not block the coupling with the touch input unit by the electric field, the SNR for the touch recognition and the remote gesture recognition may be secured even though a width of the first electrode pattern is formed so as to be equal or similar to a width of the second electrode pattern, regardless of a forming structure (the mesh pattern or the bar electrode structure of the solid type) of the second electrode pattern.

The mode selecting unit 500 may serve to select an operation mode of the touch panel of a touch recognition mode and a remote gesture recognition mode according to a selection of a user and may be configured of hardware (H/W) and software (S/W) buttons.

The first and second switching circuit units 200 and 300 are electrically connected to the first and second electrode patterns (X₁ to X₉ and Y₁ to Y₉) 110 and 130 through a switching operation according to an operation mode selection of the touch panel 100.

That is, the controlling unit 400 controls switching operations of the first switching circuit unit 200 and the second switching circuit unit 300 and driving signals applied to the first electrode patterns X₁ to X₉ and the second electrode patterns Y₁ to Y₉, and detects a change in capacitance sensed from the first electrode pattern 110 and the second electrode pattern 130.

Here, the controlling unit 400 includes a sensing circuit module 410, a signal converting module 420, an operating module 430, a driving circuit module 440, and a controller 450. The sensing circuit module 410 is connected to the second switching circuit unit 300, senses a capacitance change in the touch panel 100, and generates an analog signal (a voltage type) corresponding to the capacitance change, and the signal converting module 420 is connected to the sensing circuit module 410 and converts the analog signal (the voltage type) into a digital signal, wherein a signal converting scheme may be a time-to-digital converter (TDC) scheme measuring a time that the analog signal arrives up to a predetermined reference voltage level and converting the time into the digital signal or an analog-to-digital converter (ADC) scheme measuring an amount that a level of the analog signal is changed during a predetermined time and converting the amount into the digital signal. In addition, the operating module 430 determines the number, coordinate, gesture operation, or the like of the touch input applied to the touch panel using the digital signal, and the driving circuit module is connected to the first switching circuit unit and applies a predetermined driving signal to the touch panel.

In addition, the controller 450 controls operations of the sensing circuit module 410, the signal converting module 420, the operating module 430, the driving circuit module 440, and the first and second switching circuit units. Here, the controller 450 may be a micro controller unit (MCU).

Hereinafter, a driving scheme of the touch screen to recognize the remote gesture according to the operation mode selection of the touch panel will be described in more detail.

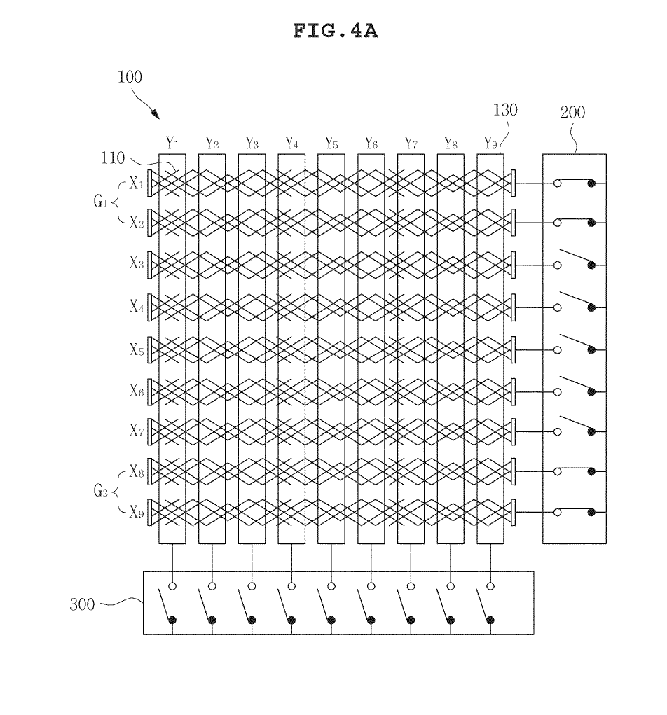

FIG. 3 is a circuit diagram showing a driving scheme in a touch recognition mode of the touch screen to recognize the remote gesture according to a preferred embodiment of the present invention.

When the user selects the touch recognition mode from the mode selecting unit 500, the controller 450 controls the switching operations of the first and second switching circuit units to thereby control the first and second circuit units so as to be electrically connected to both the first and second electrode patterns.

In addition, the driving signal module 440 sequentially applies the driving signal to the second electrode pattern 130 through the second switching circuit unit 300, and the sensing circuit module 410 detects a change in mutual-induced capacitance sensed from the respective first electrode patterns 110 according to the touch input of the user to determine a coordinate of a touch location at which the mutual-induced capacitance is changed through the operating module 430.

That is, the sensing circuit module 410 repeatedly performs processes converting a mutual capacitance value sensed from the first electrode pattern 110 into a voltage value, setting the voltage value to a base line, sequentially applying the driving signal to the second electrode pattern 130 by the driving signal module, and then detecting the mutual capacitance in the first electrode pattern 110 by the sensing circuit module 410, to thereby update the base line.

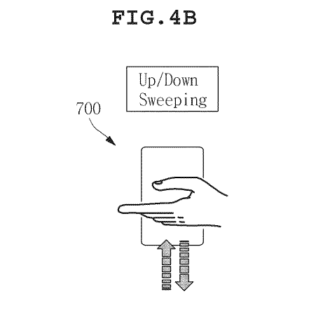

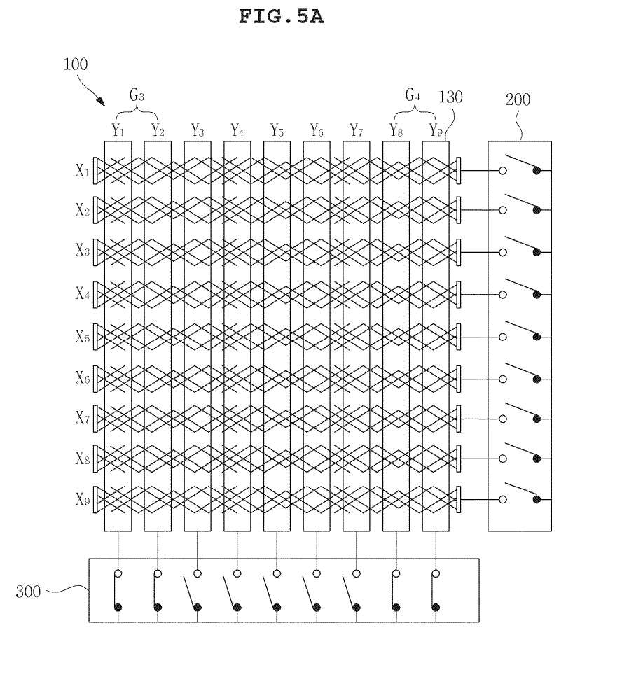

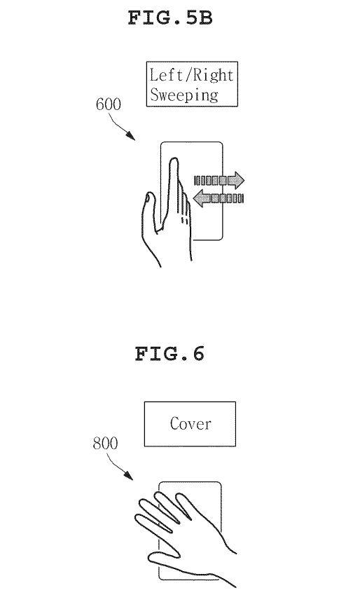

FIGS. 4A and 5A are circuit diagrams showing grouping schemes of first and second electrode patterns in the remote gesture recognition mode of the touch screen to recognize the remote gesture according to a preferred embodiment of the present invention, FIGS. 4B and 5B are diagrams showing sweeping gestures of a user in the up and down direction and the left and right direction in the case in which the first and second electrode patterns are grouped, and FIG. 6 is diagram showing a gesture for terminating the remote gesture recognition mode.

As shown in FIGS. 4A to 5B, in the case in which the user selects the remote gesture recognition mode from the mode selecting unit 500, the controller 450 controls the switching operation of the first switching circuit unit 200 to form first electrode pattern groups G₁ and G₂ comprised of one or more first electrode patterns 110 and then controls the switching operation of the second switching circuit unit 300 to form second electrode pattern groups G₃ and G₄ comprised of one or more second electrode patterns 130.

Here, the driving signal module 440 sequentially applies the driving signal to the first electrode pattern groups G₁ and G₂ through the second switching circuit unit 200, the sensing circuit module senses a time difference between changes in self-capacitances sensed from the first electrode pattern groups G₁ and G₂ and then generates an analog signal (a voltage) corresponding to the change in the capacitance, and the controller 450 determines whether or not the user inputs a gesture in the up and down direction 700 based on a result calculated by the signal converting module 420 and the operating module 430.

In addition, the controller 450 sequentially applies the driving signal to the second electrode pattern groups G₃ and G₄ through the second switching circuit unit 300 and detects the change in the self-capacitance sensed from the second electrode pattern groups G₃ and G₄, to thereby determine whether or not the user inputs a gesture in the left and right direction 600.

That is, the driving signal module 440 sequentially applies the driving signal to the second electrode pattern groups G₃ and G₄ through the second switching circuit unit 200, the sensing circuit module 410 senses a time difference between changes in self-capacitances sensed from the second electrode pattern groups G₃ and G₄ and then generates the analog signal (the voltage) corresponding to the change in the capacitance, and the controller 450 determines whether or not the user inputs the gesture in the left and right direction 700 based on the result calculated by the signal converting module 420 and the operating module 430.

In addition, the controlling unit 400 may adjust the number of the first and second electrode pattern groups, a floating of an intermediate electrode (an electrode pattern other than G₁, G₂, G₃, and G₄), and the like, to thereby adjust a range to recognize the remote gesture, and may sense a motion of the gesture of 5 cm or more to 10 cm or less based on a display of 4 inches.

In addition, as shown in FIG. 6, when a cover operation in which the gesture of the user covers the touch panel is sensed, the controlling unit 400 recognizes the cover operation as a gesture for terminating the remote gesture recognition mode and controls the switching operations of the first and second switching circuit units 200 and 300, such that all of the switches of the first and second switching circuit units 200 and 300 are electrically connected to the first and second electrode patterns 110 and 130, thereby releasing the first and second electrode pattern groups G₁, G₂, G₃, and G₄. Here, the gesture for terminating the remote gesture recognition mode is not limited to the cover operation.

As described above, according to the preferred embodiment of the present invention, slimness and lightness of the touch screen having a plurality of sensing functions may be made by grouping electrode patterns of a mutual-induced capacitive type touch screen according to the prior art by switching operations of first and second switching circuit units to generate a new sensing electrode for a self-capacitive type and integrating a touch and a remote gesture recognition function with the electrode pattern.

In addition, the portable device, the contents, or the like may be controlled by detecting a time difference in a self-capacitance change by the gesture of the user even in the situation in which the touch input from the outside is difficult to perform the function corresponding to the gesture.

In addition, the width of the first electrode pattern of the touch screen is formed in the metal mesh pattern having the width wider than that of the existing mutual induced capacitive type, thereby making it possible to secure a signal to noise ratio (SNR) available in both the recognitions of the touch and the remote gesture.

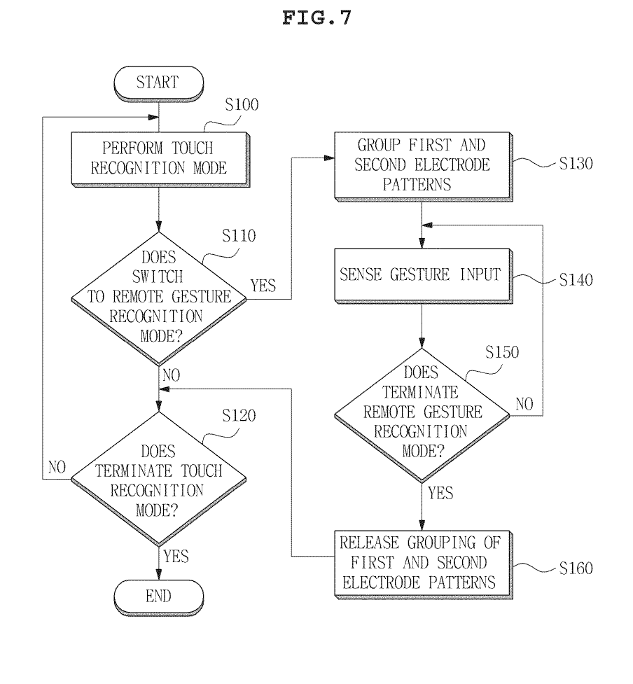

FIG. 7 is a flow chart showing a controlling method of the touch screen to recognize the remote gesture according to a preferred embodiment of the present invention. As shown in FIG. 7, the controlling method of the touch screen to recognize the remote gesture includes performing a touch recognition mode S100, selecting a mode S110, performing a remote gesture recognition mode S130 and S140, determining whether or not the remote gesture recognition mode is terminated S150, terminating the remote gesture recognition mode S160, and determining whether or not the touch recognition mode is terminated S120.

First, in the performing of the touch recognition mode S100, the driving signal module 440 sequentially applies the driving signal to the second electrode pattern 130 through the second switching circuit unit 300, and the sensing circuit module 410 detects a change in mutual-induced capacitance sensed from the respective first electrode patterns 110 according to the touch input of the user to determine a coordinate of a touch location at which the mutual-induced capacitance is changed through the operating module 430.

Next, in the selecting of the mode S110, the user selects whether or not the mode is switched from the touch recognition mode to the remote gesture recognition mode, and when the user does not select the remote gesture recognition mode, the determining of whether or not the touch recognition mode is terminated S120 is performed.

In addition, when the user selects the remote gesture recognition mode, the controlling unit 400 forms the first and second electrode pattern groups G₁, G₂, G₃, and G₄ comprised of one or more first and second electrode patterns 110 and 130 by the switching operations of the first and second switching circuit units 200 and 300 S130 and then performs the remote gesture recognition mode detecting the time difference between the changes in the self-capacitances of the first and second electrode pattern groups G₁, G₂, G₃, and G₄ according to the gesture of the user S140.

Here, the controlling unit 400 sequentially applies the driving signal to the first and second electrode pattern groups G₁, G₂, G₃, and G₄ through the first and second switching circuit units 200 and 300, and detects the time difference between the changes in the self-capacitances sensed from the first and second electrode pattern groups G₁, G₂, G₃, and G₄, to thereby determine a motion direction of the user gesture (from up to down or from left to right).

In addition, the controlling unit 400 determines whether or not a specific gesture of the user is input to thereby determine whether or not the remote gesture recognition mode is terminated S150. That is, as shown in FIG. 6, when the user inputs the cover gesture covering the touch panel, the controlling unit 400 recognizes the above-mentioned gesture as a gesture terminating the remote gesture recognition mode.

Next, when the specific gesture of the user is input, the controlling unit 400 controls the switching operations of the first and second switching circuit units 200 and 300, such that all of the switches of the first and second switching circuit units 200 and 300 are electrically connected to the first and second electrode patterns 110 and 130, thereby releasing the grouping of the first and second electrode patterns S160.

In addition, after the grouping of the first and second electrode patterns is released, the user selects whether or not the touch recognition mode is re-performed S120. That is, when the user wants to re-perform the touch recognition mode, the performing of the touch recognition mode S100 is performed again, and otherwise the touch recognition mode is terminated.

According to the preferred embodiment of the present invention, slimness and lightness of the touch screen having a multi-function may be made by grouping electrode patterns of a mutual-induced capacitive type touch screen according to the prior art by switching operations of first and second switching circuit units to generate a new sensing electrode for a self-capacitive type and integrating a touch and a remote gesture recognition function with the electrode pattern.

In addition, the portable device, the contents, or the like may be controlled by detecting a time difference in a self-capacitance change by the gesture of the user even in the situation in which the touch input from the outside is difficult to perform the function corresponding to the gesture.

In addition, the width of the first electrode pattern of the touch screen is formed in the metal mesh pattern having the width wider than that of the existing mutual induced capacitive type, thereby making it possible to secure a signal to noise ratio (SNR) available in both the recognitions of the touch and the remote gesture.

In addition, the grouping number of the first and second electrode patterns, the floating of the intermediate electrode, and the like are adjusted in the remote gesture recognition mode, such that the range to recognize the gesture may be adjusted.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch screen to recognize a remote gesture, the touch screen comprising:
a touch panel including a plurality of first and second electrode patterns formed in a direction intersected with each other on a substrate;
a mode selecting unit selecting an operation mode of the touch panel from a touch recognition mode and a remote gesture recognition mode;
a first switching circuit unit electrically connected to the first electrode pattern by a switching operation according to the selection of the operation mode of the touch panel;
a second switching circuit unit electrically connected to the second electrode pattern by a switching operation according to the selection of the operation mode of the touch panel; and
a controlling unit controlling the switching operations of the first switching circuit unit and the second switching circuit unit and a driving signal applied to the first electrode pattern and the second electrode pattern, and detecting changes in capacitance sensed from the first electrode pattern and the second electrode pattern according to the selection of the operation mode of the touch panel.

2. The touch screen as set forth in claim 1, wherein when the touch recognition mode is selected from the mode selecting unit,
the first switching circuit unit is electrically connected to all of the first electrode patterns by the switching operation,
the second switching circuit unit is electrically connected to all of the second electrode patterns by the switching operation, and
the controlling unit sequentially applies the driving signal to the second electrode patterns through the second switching circuit unit, detects a change in mutual capacitance sensed from the first electrode patterns, and determines a touch location.

3. The touch screen as set forth in claim 1, wherein when the remote gesture recognition mode is selected from the mode selecting unit,
the first switching circuit unit forms a first electrode pattern group comprised of one or more first electrode patterns by the switching operation;
the second switching circuit unit forms a second electrode pattern group comprised of one or more second electrode patterns by the switching operation, and
the controlling unit sequentially applies the driving signal to the first electrode pattern group through the first switching circuit unit, senses a time difference between changes in self-capacitances in the first electrode pattern group according to a gesture input in an up and down direction by a user, and determines whether or not the user inputs the gesture in the up and down direction, and sequentially applies the driving signal to the second electrode pattern group through the second switching circuit unit, senses a time difference between changes in self-capacitances in the second electrode pattern group according to a gesture input in a left and right direction by the user, and determines whether or not the user inputs the gesture in the left and right direction.

4. The touch screen as set forth in claim 1, wherein the touch panel includes the substrate, the first electrode patterns formed on one surface of the substrate so as to be parallel with each other in one direction, and the second electrode patterns formed on a rear surface of the substrate and formed so as to be parallel with each other in a direction intersecting with the first electrode patterns.

5. The touch screen as set forth in claim 4, wherein the first electrode pattern is a mesh pattern.

6. The touch screen as set forth in claim 5, wherein the first electrode pattern has a width similar to a width of the second electrode pattern.

7. The touch screen as set forth in claim 1, wherein the controlling unit includes:
a driving circuit module applying a predetermined driving signal to the touch panel,
a sensing circuit module sensing a change in the capacitance in the touch panel and generating an analog signal corresponding to the change,
a signal converting module converting the analog signal into a digital signal,
an operating module operating a coordinate of a touch input applied to the touch panel using the digital signal, and
a controller controlling the first and second switching circuit units, the driving circuit module, the signal converting module, and the operating module.

8. A controlling method of a touch screen to recognize a remote gesture, the method comprising:
performing a touch recognition mode detecting a change in mutual induced capacitance sensed from a first electrode pattern according to a driving signal sequentially applied to a second electrode pattern of a touch panel to thereby determine a touch location;
selecting a mode selecting whether or not switching from the touch recognition mode to a remote gesture recognition mode;
when the remote gesture recognition mode is selected, performing the remote gesture recognition mode forming first and second electrode pattern groups and then sensing a time difference between changes in self-capacitance in the first and second electrode pattern groups according to a gesture of a user; and
determining whether or not terminating the remote gesture recognition mode selecting whether or not switching from the remote gesture recognition mode to the touch recognition mode according to whether or not a specific gesture is input.

9. The method as set forth in claim 8, wherein the touch panel includes a substrate, the first electrode patterns formed on one surface of the substrate so as to be parallel with each other in one direction, and the second electrode patterns formed on a rear surface of the substrate and formed so as to be parallel with each other in a direction intersecting with the first electrode patterns.

10. The method as set forth in claim 8, wherein the first electrode pattern is a mesh pattern.

11. The method as set forth in claim 10, wherein the first electrode pattern has a width similar to a width of the second electrode pattern.

12. The method as set forth in claim 8, wherein in the performing of the remote gesture recognition mode,
the first electrode pattern group comprised of one or more first electrode patterns is formed by a switching operation of a first switching circuit unit, and
the second electrode pattern group comprised of one or more second electrode patterns is formed by a switching operation of a second switching circuit unit.

13. The method as set forth in claim 12, wherein in the performing of the remote gesture recognition mode,
the driving signal is sequentially applied to the first electrode pattern group through the first switching circuit unit and a time difference between changes in self-capacitances in the first electrode pattern group according to a gesture input by a user in an up and down direction is sensed to thereby determine whether or not the user inputs a gesture in the up and down direction, and
the driving signal is sequentially applied to the second electrode pattern group through the second switching circuit unit and a time difference between changes in self-capacitances in the second electrode pattern group according to a gesture input by the user in a left and right direction is sensed to thereby determine whether or not the user inputs a gesture in the left and right direction.

14. The method as set forth in claim 8, wherein after the determining of whether or not terminating the remote gesture recognition mode, when the remote gesture recognition mode is not terminated, the performing of the remote gesture recognition mode is repeatedly performed.

15. The method as set forth in claim 8, further comprising, after the determining of whether or not terminating the remote gesture recognition mode, releasing the first and second electrode pattern groups by electrically connecting the first switching circuit unit to all of the first electrode patterns through a switching operation and electrically connecting the second switching circuit unit to all of the second electrode patterns through a switching operation when the remote gesture recognition mode is terminated.

16. The method as set forth in claim 15, further comprising, after the releasing of the first and second electrode pattern groups, determining whether or not terminating the touch recognition mode determining whether or not re-performing the touch recognition mode.
